(19) United States
(12) Patent Application Publication
(10) Pub. No.: US 2025/0280019 A1
(43) Pub. Date: Sep. 4, 2025

(54) ANOMALY DETECTION IN OPERATIONAL TECHNOLOGY ENVIRONMENT

(71) Applicant: Honeywell International Inc., Charlotte, NC (US)

(72) Inventors: Atul Bassi, Bangalore (IN); Anubhav Misra, Bangalore (IN); Tarun Gupta, Bangalore (IN)

(21) Appl. No.: 18/804,054

(22) Filed: Aug. 14, 2024

(30) Foreign Application Priority Data
Mar. 1, 2024 (IN) 202411015485

(51) Int. Cl. H04L 9/40

(52) U.S. Cl. CPC H04L 63/1425; H04L 63/101

(57) ABSTRACT

Approaches for automated and efficient detection of anomalies in operational technology (OT) environments are described. According to one example, real-time operation data corresponding to an entity operating within an OT environment of an organization may be obtained. The real-time operation data may be indicative of operations performed by the entity within the OT environment. For each of the operations, operational information associated with the operation may be identified. The real-time operation data and the operational information may be processed, utilizing the anomaly detection model, to detect any anomaly in the operations. One or more preventive actions may be initiated within the OT environment upon detecting an anomaly in at least one of the operations.

### BACKGROUND

Generally, across all industries, numerous operations are performed on a daily basis in a controlled operational environment. For example, in industrial sectors, such as oil, gas, mining, chemicals, energy, manufacturing, and defense, the industries include an operational technology (OT) environment for monitoring and controlling physical industrial processes and for taking business decisions such as for scheduling of production, for use of material, for shipping, etc. The OT environment may include processing equipment and field devices, such as sensors and actuators, which perform physical processes of the industries. Further, the OT environment may include devices for managing production workflows and instruments for sending commands to the processing equipment and field devices. Furthermore, the OT environment may include an industrial control system (ICS) such as a distributed control system (DCS) or a supervisory control and data acquisition (SCADA) system for supervising, monitoring, and controlling the physical processes.

With large scale digitalization, most of the industrial processes are also being automated to enhance operational efficiency and enable data-driven decision-making and remote management. For such automation, the OT environment has become increasingly interconnected with wired and wireless networks, including the Internet, to collect, analyze, and leverage data on industry's premises and in the cloud. Thus, the OT environments have become increasingly exposed to cyber threats that may compromise the safety and reliability of the industrial operations.

### BRIEF DESCRIPTION OF FIGURES

Systems and/or methods are now described, in accordance with examples of the present subject matter and with reference to the accompanying figures, in which:

FIG. 1 illustrates a system for detecting an anomaly in an operational technology (OT) environment, according to an example;

FIG. 2A and FIG. 2B illustrate a computing environment implementing the system for detecting an anomaly in an OT environment, according to another example;

FIG. 3 illustrates a data flow diagram for detecting an anomaly in an OT environment, according to an example;

FIG. 4 illustrates a method for detecting an anomaly in an OT environment, according to an example;

FIG. 5A to FIG. 5C illustrate a method for training of a machine learning model for detecting an anomaly in an OT environment, according to an example;

FIG. 6A to FIG. 6C illustrate a method for detecting an anomaly in an OT environment, according to another example; and

FIG. 7 illustrates a computing environment implementing a non-transitory computer-readable medium for detecting an anomaly in an OT environment, according to an example.

### DETAILED DESCRIPTION

OT environments are vital for effective operation of industrial processes. The connectivity of the OT environments to wired or wireless networks exposes the OT environments to cyber threats that may compromise the safety and reliability of industrial operations. Cyber-attacks directed at systems or devices within the OT environments may result in an unauthorized access of critical industrial data, data breaches, interruption of crucial processes, and monetary losses. Inefficient cybersecurity for the OT environments of an organization may thus result in undesired operational disruptions, system failures, and downtime, thereby leading to severe consequences, including production delays, decreased efficiency of the OT environment, reputational damage for the organization, and financial losses for the organization.

Inadequate OT cybersecurity may further cause safety risks to employees of the organization, the public, and the environment. For example, cyber-attacks targeting the OT environments in industries such as manufacturing, energy, transportation, etc., may potentially lead to dangerous accidents, equipment malfunctions, or environmental disasters, jeopardizing human lives and causing significant damage to the environment and the organization's infrastructure. Such accidents or disasters may even lead to non-compliance of standard regulations due to which the organization may suffer regulatory penalties, legal repercussions, and reputational harm. Inefficient cybersecurity for the OT environments may put the organization at a competitive disadvantage due to lack of trust in customers, partners, and other stakeholders.

Once the security of the OT environment is breached, addressing vulnerabilities in the OT cybersecurity may be expensive. For example, the organization may need to cover expenses for the loss in productivity due to the downtime, court costs, fines, customer compensation, and damage control costs, and even compensation to cyber attackers involved in the breach. Thus, organizations implement security measures for prevention of cyber-attacks on the OT environments.

Traditional security measures make use of pre-defined rules for monitoring and filtering network traffic which is being received at the OT environment and which is going out of the OT environment. Such pre-defined rules are typically created once and are then used for a long time. Such pre-defined rules are generally created based on known type of cyber-attacks.

However, such traditional security measures prove to be insufficient against detection of any anomaly in the OT environment. This is because the number and sophistication of cyber-attacks is continuously increasing day by day. Moreover, it is challenging for the organizations to stay updated on the most recent threats and vulnerabilities because of the scattered information, lack of centralized/right expertise, and limited sharing of latest threats among organizations. As a result, the OT environments become more susceptible to cyber-attacks if the traditional security measures are continued.

Moreover, there may be numerous users within the organization. A specific user of the organization may have authorization to monitor and control a specific industrial operation while another user may have authorization to monitor and control another industrial operation. Existing techniques for detecting cyber-attacks fail to effectively identify if a particular action is an anomaly or not. For example, the existing techniques fail to identify if the particular action is initiated by an authorized user, a malicious user, or an unauthorized user. Therefore, there is a need for security measures which can efficiently prevent cyber-attacks on the OT environments.

The present subject matter describes approaches for automated and efficient detection of anomalies in operational technology (OT) environments. The approaches include analyzing real-time operation data corresponding to an entity operating within an OT environment of an organization. In an example, the entity may be an asset such as a device, a system, or a machine associated with the organization. In another example, the entity may be a user operating one or more assets associated with the organization. The real-time operation data may be indicative of one or more operations performed by the entity within the OT environment. Operations performed by each entity operating within the OT environment may be individually monitored in real-time to detect any anomaly in the operations. In an example, behavior-based monitoring may be implemented to detect performance of any operation that is not typically performed by the entity while operating within the OT environment. In addition or alternatively, role-based monitoring may be implemented to detect performance of any operation that the entity is not authorized to perform according to the role and responsibilities assigned to that entity. Upon detecting an anomaly in at least one of the operations, one or more preventive actions may be initiated within the OT environment for preventing occurrence of any undesirable event within the OT environment. The claimed invention utilizes a generative artificial intelligence (AI) model that may be referred to as an anomaly detection model for implementing the behavior-based monitoring and the role-based monitoring. The anomaly detection model may be utilized in conjunction with behavior analytics for tracking behavior of an entity over time, thereby, enabling detection of anomalies in real-time, so that appropriate action may be timely taken to prevent occurrence of any unwanted circumstances. The described approaches thus provide a simple and robust analytical methodology for early, quick, efficient, and automated detection of anomalies in the OT environment. Further, the anomaly detection model may facilitate in providing a dynamic and adaptive cybersecurity system.

In an example implementation of the present subject matter, for enabling the role-based monitoring, historical role-specific activity data may be analyzed to obtain an initial version of the anomaly detection model. The historical role-specific activity data may indicate ideal operations performed within one or more OT environments of one or more organizations, by a plurality of authorized entities that is authorized to perform operations corresponding to roles assigned in at least one of the one or more organizations. Thus, the anomaly detection model may be trained to understand what operations are normally performed by entities assigned with different roles and responsibilities across organizations.

In an example implementation of the present subject matter, for enabling the behaviour-based monitoring, historical operation data corresponding to one or more entities associated with the organization may be obtained. The historical operation data may be indicative of one or more historical operations performed by each of the one or more entities within the OT environment of the organization. For each of the one or more historical operations, a particular historical time at which the historical operation was performed may be identified. The historical operation data may then be analyzed in correlation with the particular historical time to obtain a final trained version of the anomaly detection model. Thus, the anomaly detection model may be trained to understand an ideal operational behavior of each of the one or more entities over a period of time.

In an example, for implementing the behavior-based monitoring for an entity using the anomaly detection model, timing information may be identified for each of one or more operations performed by the entity. The timing information may indicate a particular time at which the operation was performed. Further, a historical behaviour-based pattern of the entity may be obtained. The historical behaviour-based pattern may be indicative of historical operations performed by the entity at the particular time. The historical operations may be compared with the one or more operations to detect the anomaly. The anomaly may be detected upon detecting a deviation of at least one operation of the one or more operations from the historical operations.

In an example, for implementing the role-based monitoring for an entity using the anomaly detection model, role-based access control (RBAC) information may be identified for each of one or more operations performed by the entity. The RBAC information may indicate authorization details and responsibilities assigned to the entity for operating within the OT environment. Further, a historical role-based pattern may be obtained for the entity. The historical role-based pattern may be indicative of ideal operations performed by an ideal entity having authorization to operate within an ideal OT environment according to the authorization details and responsibilities. The ideal operations may be compared with the one or more operations to detect the anomaly. The anomaly may be detected upon detecting a deviation of at least one operation of the one or more operations from the ideal operations.

In an example, the one or more preventive actions that may be initiated upon detecting an anomaly in at least one of the one or more operations may include generation of a suspension signal for transmission to one or more devices associated with the organization. The suspension signal may prevent execution of the one or more operations for which the anomaly is detected. Further, the one or more preventive actions may include generation of an alert notification for transmission to a supervisor on a supervisor device. The alert notification may be indicative of the anomaly, enabling the supervisor to proactively engage in adversary pursuit and threat hunting.

Since the anomaly detection model is obtained through training on the historical role-specific activity data and the historical operation data, the described approaches may enable easy and quick detection of anomalies within the OT environment by identifying role-based or behavior-based deviations in operations performed by an entity within the OT environment. As a result, cyber-attacks on the OT environments may be prevented without a need for organizations to stay updated on the most recent types of cyber-threats and vulnerabilities.

The described approaches utilize advanced behavioral analytics and machine learning platforms to efficiently process high volume of historical data from organizations for detecting the anomalies in real-time. Any person or machine that interacts with a company, system, platform, plant assets or product of an organization can be a subject of the behavioral analytics. The described approaches make the organizations capable of collating and analyzing operations from various IT/OT sources in real-time to identify potential issues before such operations can impact the OT environment. That is, a high volume of raw event data including operations from interactions across multiple channels is ingested, looking at everything from time to time, enabling quick detection of the anomalies. This proactive detection reduces the likelihood of successful cyberattacks, reducing the amount of time for which an adversary is in the OT environment, and minimizes business disruption. Upon detecting an anomaly, a corrective measure may be taken immediately and any suspicious activity may be immediately arrested at the moment of detection. Thus, the described approaches provide a comprehensive protection against cyber-attacks and enable a robust cybersecurity for the OT environment which enhances the reputation of the organization and the trust in customers, partners, and other stakeholders. Thus, the organization may be protected from safety hazards and covering expenses which would have otherwise been required to be covered in case of any undesired event. Further, the described approaches help the organizations to avoid reputational damage, regulatory penalties, legal repercussions, or jeopardizing the customer's lives.

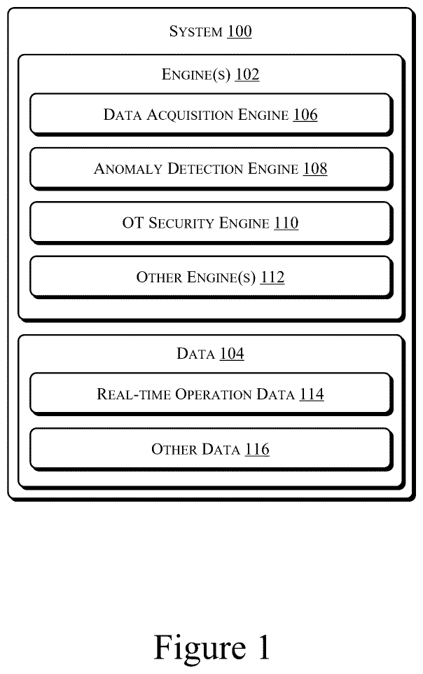

The present subject matter is further described with reference to FIG. 1 to FIG. 7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for detecting an anomaly in an operational technology (OT) environment, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location. In an example, the system 100 may be utilized by organizations that aim to secure their OT environments from cyber-attacks.

In one example, the system 100 may include engine(s) 102 and data 104. The system 100 may also include additional components, such as display, input/output interfaces, operating systems, applications, and other software or hardware components (not shown in the figures).

The engine(s) 102 may be implemented as a combination of hardware and programming, for example, programmable instructions to implement a variety of functionalities of the engine(s) 102. In examples described herein, such combinations of hardware and programming may be implemented in several different ways. For example, the programming for the engine(s) 102 may be executable instructions. Such instructions may be stored on a non-transitory machine-readable storage medium which may be coupled either directly with the system 100 or indirectly (for example, through networked means). In an example, the engine(s) 102 may include a processing resource, for example, either a single processor or a combination of multiple processors, to execute such instructions. In the present examples, the non-transitory machine-readable storage medium may store instructions that, when executed by the processing resource, implement the engine(s) 102. In other examples, the engine(s) 102 may be implemented as electronic circuitry.

In one example, the engine(s) 102 may include a data acquisition engine 106, an anomaly detection engine 108, an OT security engine 110, and other engine(s) 112. The other engine(s) 112 may further implement functionalities that supplement functions performed by the system 100 or any of the engine(s) 102.

The data 104 includes data that is either received, stored, or generated as a result of functions implemented by any of the engine(s) 102 or the system 100. It may be further noted that information stored and available in the data 104 may be utilized by the engine(s) 102 for performing various functions of the system 100. The data 104 may include real-time operation data 114 and other data 116. The real-time operation data 114 may be indicative of one or more operations performed, in real-time, within the OT environment of an organization hosting the system 100. The other data 116 may include data that is either received, stored, or generated as a result of functions implemented by any of the engine(s) 102.

In operation, the data acquisition engine 106 may obtain real-time operation data corresponding to an entity operating within an OT environment of an organization. The real-time operation data may be indicative of one or more operations performed by the entity within the OT environment. In an example, the entity may be an asset such as a device, a system, or a machine associated with the organization. In another example, the entity may be a user operating one or more assets associated with the organization. In an example, the real-time operation data may be obtained from the asset operating within the OT environment. In another example, the real-time operation data may be obtained from a centralized server managing operations performed within the OT environment of the organization. In one example, the real-time operation data may be stored as the real-time operation data 114.

Once the real-time operation data is obtained, for each of the one or more operations, the anomaly detection engine 108 may identify operational information associated with the operation. In an example, the operational information may comprise at least one of timing information and role-based access control (RBAC) information. The timing information may indicate a particular time at which the operation was performed. Further, the RBAC information may indicate authorization details and responsibilities assigned to the entity for operating within the OT environment. For example, the organization may have users which are assigned with respective roles such as “operator”, “engineer”, and “supervisor”. According to the role assigned by the organization, the entity may have a pre-defined set of responsibilities and access permissions which may hereinafter be referred to as the authorization details and responsibilities. In an example, the anomaly detection engine 108 may implement an anomaly detection model to identify the operational information. The anomaly detection model may be a generative artificial intelligence (AI) model trained on historical data to detect anomalies within the OT environment.

The anomaly detection engine 108 may process the real-time operation data and the operational information to detect any anomaly in the one or more operations. In an example, the anomaly detection engine 108 may utilize the anomaly detection model to process the real-time operation data and the operational information. In an example, an anomaly may be detected whenever any operation in the one or more operations is detected that is not typically performed by the entity at the particular time while operating within the OT environment. In addition, or alternatively, an anomaly may be detected whenever any operation in the one or more operations is detected that does not correspond to the authorization details and responsibilities assigned to the entity.

Subsequently, the OT security engine 110 may initiate one or more preventive actions within the OT environment upon detecting an anomaly in at least one of the one or more operations. In an example, the one or more preventive actions may include alerting a supervisor about the anomaly so that the supervisor may proactively engage in adversary pursuit and threat hunting. In an example, the one or more preventive actions may include controlling one or more devices associated with the organization to prevent execution of the one or more operations for which the anomaly is detected. Thus, the described approaches provide a simple and robust analytical methodology for early, quick, efficient, and automated detection of anomalies in the OT environment. Further, the anomaly detection model may facilitate in providing a dynamic and adaptive cybersecurity system.

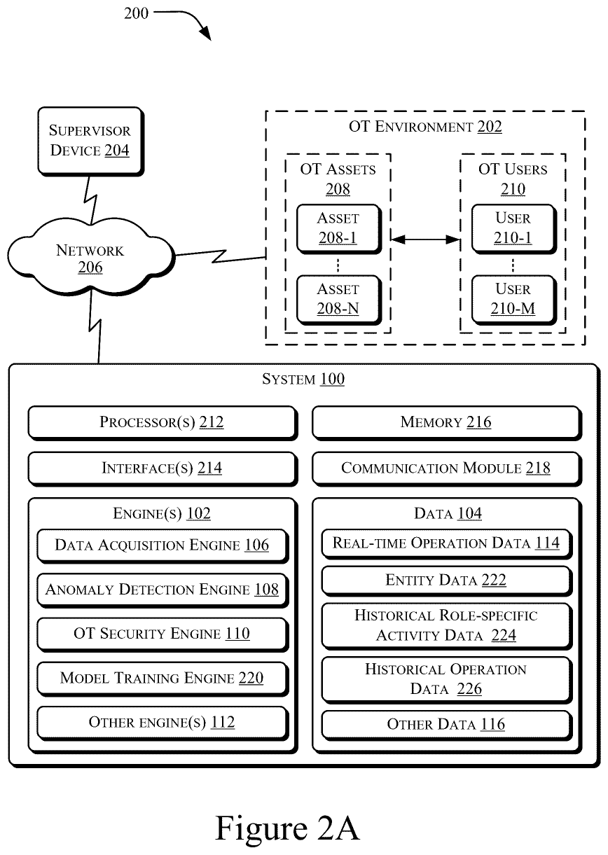

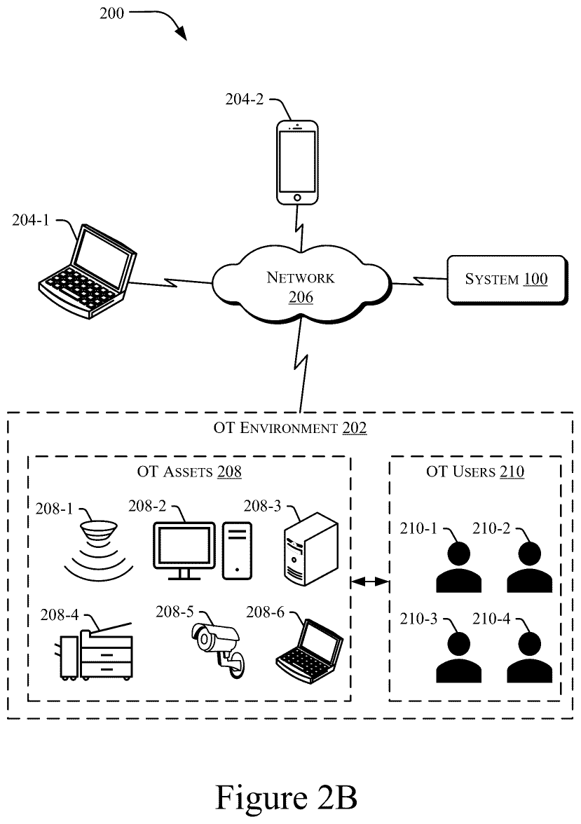

FIG. 2A and FIG. 2B illustrate a computing environment 200 implementing the system 100 for detecting an anomaly in an OT environment 202, according to another example. In one example, the computing environment 200 may include the system 100, the OT environment 202, and a supervisor device 204.

In an example, the OT environment 202 may be associated with a particular organization. The OT environment 202 may include OT assets 208 and OT users 210. The OT assets 208 may be assets 208-1, . . . , 208-N belonging to the organization, where N may be a natural number. The assets 208-1, . . . , 208-N may be individually referred to as asset 208 and collectively referred to as the OT assets 208. The asset 208 may be a processing equipment, a field device, an electronic device, a system, or any machine operating within the OT environment of the organization. Physical processes of the organization, production workflows of the organization, and control parameters for processing equipment or field devices operating within the OT environment 202 may be controlled through the OT assets 208. In an example, the asset 208 may be a processing equipment or a field device, such as a sensor or an actuator, which performs physical industrial processes of the organization. In another example, the asset 208 may be a device for managing production workflows. In yet another example, the asset 208 may be an instrument for sending commands to the processing equipment or the field device. In yet another example, the asset 208 may be an industrial control system (ICS) such as a distributed control system (DCS) or a supervisory control and data acquisition (SCADA) system for supervising, monitoring, and controlling the physical processes. As exemplarily illustrated in FIG. 2B, examples of the asset 208 may include, but are not limited to, a sensor 208-1, a computer 208-2, a server 208-3, a printing machine 208-4, a camera 208-5, and a laptop 208-6, operating within the OT environment. The sensor 208-1 may be any type of sensor, such as a temperature sensor and a pressure sensor. The server 208-3 may store and manage data associated with the organization and the assets 208. Although only hardware components have been illustrated as the OT assets 208 in FIG. 2B, it should be understood that the OT assets 208 may also include software assets utilized by the organization for implementing various industrial processes. In an example, the asset 208 may perform one or more operations based on direct interaction with at least one of the OT users 210. In another example, the asset 208 may perform one or more operations without direct interaction with the OT users 210.

The OT users 210 may be users 210-1, . . . , 210-M associated with the organization, where M may be a natural number. The users 210-1, . . . , 210-M may be individually referred to as user 210 and collectively referred to as the OT users 210. The user 210 may interact with at least one of the OT assets 208 to cause the asset 208 to perform one or more operations. FIG. 2B exemplarily illustrates user A 210-1, user B 210-2, user C 210-3, and user D 210-4. Although four OT users 210 have been illustrated as an example, it should be understood that the OT environment may include any number of the OT users 210. The user 210 may be assigned a corresponding role within the organization. The corresponding role may be associated with pre-defined responsibilities and pre-defined permissions to interact and access the OT assets 208. For example, user A 210-1 may be assigned permission to control some features in the laptop 208-6, while user B 210-2 may be assigned permission to read data managed by the server 208-3. Further, user C 210-3 may be responsible to control the operation of the printing machine 208-4 based on data generated by the sensor 208-1, while user D may be responsible to control the operation of the camera 208-5 using the computer 208-2. Similarly different users 210 may be assigned respective responsibilities and respective permissions for accessing and controlling one or more of the OT assets 208.

In an example, the supervisor device 204 may be a device over which the system 100 may provide notification to a user, such as a supervisor of an organization, about anomalies detected within an OT environment of the organization. The supervisor device 204 may be accessed by the supervisor associated with the organization. In an example, the supervisor may access the supervisor device 204 to receive alerts regarding the anomalies. As exemplarily illustrated in FIG. 2B, examples of the supervisor device 204 may include, but are not limited to, a laptop 204-1 and a mobile phone 204-2. Examples of the supervisor device 204 may also include, but are not limited to, a desktop, a tablet computer, a personal digital assistant (PDA) and any electronic device capable of transmitting or receiving data. Although one supervisor device 204 has been illustrated in FIG. 2A and two supervisor devices 204-1 and 204-2 have been illustrated in FIG. 2B for the sake of brevity, it should be understood to a person skilled in the art that any number of supervisor devices 204 may be connected with the system 100 to receive alerts about the anomalies.

The system 100, the OT environment 202, and the supervisor device 204 may be communicably coupled with each other over a communication network 206 and may exchange data and signals over the communication network 206. The communication network 206 may be a wireless network, a wired network, or a combination thereof. The communication network 206 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 206 may include various network entities, such as transceivers, gateways, and routers. In an example, the communication network 206 may include any communication network that uses any of the commonly used protocols, for example, Hypertext Transfer Protocol (HTTP), and Transmission Control Protocol/Internet Protocol (TCP/IP).

In one example, the system 100 may include processor(s) 212, interface(s) 214, memory 216, a communication module 218, the engine(s) 102, and the data 104. The system 100 may also include other components, such as display, input/output interfaces, operating systems, applications, and other software or hardware components (not shown in the figures).

The processor(s) 212 may be implemented as microprocessors, microcomputers, microcontrollers, digital signal processors, central processing units, state machines, logic circuitries, and/or other devices that manipulate signals based on operational instructions. The interface(s) 214 may allow the connection or coupling of the system 100 with one or more other devices, such as the supervisor device 204 and the OT assets 208 within the OT environment 202, through a wired (e.g., Local Area Network, i.e., LAN) connection or through a wireless connection (e.g., Bluetooth®, Wi-Fi). The interface(s) 214 may also enable intercommunication between different logical as well as hardware components of the system 100.

The memory 216 may be a computer-readable medium, examples of which include volatile memory (e.g., RAM), and/or non-volatile memory (e.g., Erasable Programmable read-only memory, i.e., EPROM, flash memory, etc.). The memory 216 may be an external memory or an internal memory, such as a flash drive, a compact disk drive, an external hard disk drive, or the like. The memory 216 may further include the data 104 and/or other data which may either be received, utilized, or generated during the operation of the system 100.

The communication module 218 may be a wireless communication module. Examples of the communication module 218 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 218 may also include one or more antennas to enable wireless transmission and reception of data and signals. The communication module 218 may allow the system 100 to transmit data and signals to one or more other devices, such as the supervisor device 204 and the OT assets 208 within the OT environment 202; and receive data and signals from the one or more other devices.

The engine(s) 102 may include the data acquisition engine 106, the anomaly detection engine 108, the OT security engine 110, and the other engine(s) 112, as explained with reference to FIG. 1. In an example, the engine(s) 102 may further include a model training engine 220.

The data 104 may include the real-time operation data 114 and the other data 116, as explained with reference to FIG. 1. In an example, the data 104 may further include entity data 222, historical role-specific activity data 224, and historical operation data 226. In an example, the entity data 222 may include role-based access control (RBAC) information for each entity, such as the asset 208 and the user 210, operating within the OT environment 202. The RBAC information may define role and responsibility of the entity within the organization. That is, the RBAC information may indicate authorization details and responsibilities assigned to the entity for operating within the OT environment 202. In an example, the entity data 222 may be obtained from the OT assets 208 or the OT users 210 operating within the OT environment 202. In another example, the entity data 222 may be pre-stored in the memory 216 of the system 100. The historical role-specific activity data 224 may be historical data indicating ideal operations performed within one or more OT environments of one or more organizations, by a plurality of authorized entities authorized to perform operations corresponding to roles assigned in at least one of the one or more organizations. In an example, the historical role-specific activity data 224 may be ideal operations generally performed according to each of a plurality of pre-defined roles across different organizations. In an example, the historical role-specific activity data 224 may be industry-specific ideal operations performed according to each of a plurality of pre-defined roles across different organizations belonging to a particular industry. For example, the historical role-specific activity data 224 may indicate ideal operations performed by engineers in a manufacturing industry. The historical operation data 226 may correspond to one or more entities associated with the organization. The historical operation data 226 may be indicative of one or more historical operations performed by each of the one or more entities within the OT environment 202 of the organization. In an example, the historical operation data 226 may include historical timing information for each of the one or more historical operations. The historical timing information may indicate a particular historical time at which the historical operation was performed. In an example, the historical operation data 226 may be obtained from the OT assets 208 or the OT users 210 operating within the OT environment 202.

In operation, for enabling detection of anomalies in operations performed within the OT environment 202, the model training engine 220 of the system 100 may be configured to train an anomaly detection model. The anomaly detection model may be a generation AI model that can identify patterns in data provided for training to use such patterns for detection of the anomalies in real-time.

In an example, for training the anomaly detection model, the model training engine 220 may obtain historical role-specific activity data. The historical role-specific activity data may indicate ideal operations performed within one or more OT environments of one or more organizations, by a plurality of authorized entities authorized to perform operations corresponding to roles assigned in at least one of the one or more organizations. In an example, the historical role-specific activity data may indicate ideal operations generally performed according to each of a plurality of pre-defined roles across different organizations. In an example, the historical role-specific activity data may indicate industry-specific ideal operations performed according to each of the plurality of pre-defined roles across different organizations belonging to a particular industry. Examples of the plurality of pre-defined roles may include, but are not limited to, an operator, an engineer, and a supervisor. For example, the historical role-specific activity data may indicate ideal operations performed by engineers in a manufacturing industry. In an example, the historical role-specific activity data may be pre-stored in the historical role-specific activity data 224.

Once the historical role-specific activity data is obtained, the model training engine 220 may analyze the historical role-specific activity data to obtain an initial version of the anomaly detection model. In an example, the initial version of the anomaly detection model may be utilized to implement role-based monitoring of operations performed within the OT environment 202. The role-based monitoring may involve detecting any particular operation that is performed by a particular entity which is not authorized to perform that particular operation according to the role and responsibilities assigned to the particular entity.

In an example, for analyzing the historical role-specific activity data, the model training engine 220 may identify corresponding role-based access control (RBAC) details for each of the plurality of authorized entities. The corresponding RBAC details may indicate authorization details and responsibilities assigned to the authorized entity for operating within the one or more OT environments as per the roles assigned to the authorized entity in at least one of the one or more organizations.

Subsequently, the model training engine 220 may identify a historical role-based pattern for each of the plurality of authorized entities. The historical role-based pattern may be indicative of a correlation between the ideal operations and the corresponding RBAC details. Thus, the historical role-based pattern provides a typical pattern of operations performed by users that are assigned a particular role within the one or more organizations. For example, the historical role-based pattern may indicate what operations are typically performed by engineers within one or more organizations.

The model training engine 220 may then train the anomaly detection model based on the historical role-based pattern to obtain the initial version of the anomaly detection model.

In addition, or alternatively, for training the anomaly detection model, the model training engine 220 may obtain historical operation data corresponding to one or more entities associated with an organization for which the anomaly detection model is to be utilized for detection of anomalies. The historical operation data may be indicative of one or more historical operations performed by each of the one or more entities within the OT environment 202 of the organization. In an example, the historical operation data may include historical timing information for each of the one or more historical operations. The historical timing information may be indicative of a particular historical time at which the historical operation was performed. In an example, the historical operation data may be obtained from the OT assets 208 or the OT users 210 operating within the OT environment 202. In an example, the historical operation data may be pre-stored in the historical operation data 226.

Once the historical operation data is obtained, for each of the one or more historical operations, the model training engine 220 may identify the particular historical time at which the historical operation was performed. Further, the model training engine 220 may analyze the historical operation data in correlation with the particular historical time to obtain a final trained version of the anomaly detection model. The final trained version of the anomaly detection model may be utilized to implement behavior-based monitoring of operations performed within the OT environment 202 of the organization for which the final trained version of the anomaly detection model is obtained. The behavior-based monitoring may involve detecting any particular operation that is performed by an entity that does not typically perform that particular operation at the time at which the particular operation is performed.

In an example, for analyzing the historical operation data, the model training engine 220 may identify a historical behaviour-based pattern for the entity. The historical behaviour-based pattern may be indicative of a correlation between the one or more historical operations and the particular historical time. Thus, the historical behaviour-based pattern provides a typical pattern of how assets 208 within the OT environment 202 operate at different times. For example, the historical behaviour-based pattern may indicate what operations are performed by the asset 208 at a particular time. For instance, actuators within the OT environment may operate for one hour and then rest without operating for five minutes. Similar patterns may be detected for the assets 208 operating within the OT environment 202 in correlation with the time of operation.

The model training engine 220 may then optimize the initial version of the anomaly detection model based on the historical behaviour-based pattern to obtain the final trained version of the anomaly detection model.

For utilizing the anomaly detection model to detect anomalies in real-time, the data acquisition engine 106 may obtain real-time operation data corresponding to an entity operating within the OT environment 202 of the organization. The real-time operation data may be indicative of one or more operations performed by the entity within the OT environment 202. In an example, the entity may be the asset 208 associated with the organization. In another example, the entity may be the user 210 operating the asset 208 associated with the organization. In an example, the real-time operation data may be obtained from the OT assets 208 operating within the OT environment 202. In another example, the real-time operation data may be obtained from a centralized server, say the server 208-3, managing operations performed within the OT environment 202 of the organization. The real-time operation data may be obtained for real-time monitoring of the one or more operations to enable detection of the anomalies. In one example, the real-time operation data may be stored as the real-time operation data 114.

Once the real-time operation data is obtained, for each of the one or more operations, the anomaly detection engine 108 may identify operational information associated with the operation. In an example, the operational information may comprise at least one of timing information and role-based access control (RBAC) information. The timing information may indicate a particular time at which the operation was performed. In an example, the real-time operation data include a time-stamp tag corresponding to each of the one or more operations and the timing information may accordingly be identified based on the time-stamp tag. Further, the RBAC information may indicate authorization details and responsibilities assigned to the entity for operating within the OT environment 202. For example, the organization may have users 210 which are assigned with respective roles such as “operator”, “engineer”, and “supervisor”. According to the role assigned by the organization, the entity may have a pre-defined set of responsibilities and access permissions which may hereinafter be referred to as the authorization details and responsibilities. In an example, the anomaly detection engine 108 may implement the anomaly detection model to identify the operational information. In an example, the RBAC information may be stored in the entity data 222.

The anomaly detection engine 108 may process the real-time operation data and the operational information to detect any anomaly in the one or more operations. In an example, the anomaly detection engine 108 may utilize the anomaly detection model to process the real-time operation data and the operational information. In an example, an anomaly may be detected whenever any operation in the one or more operations is detected that is not typically performed by the entity at the particular time while operating within the OT environment 202. In addition, or alternatively, an anomaly may be detected whenever any operation in the one or more operations is detected that does not correspond to the authorization details and responsibilities assigned to the entity.

In an example, for processing the real-time operation data and the operational information, the anomaly detection engine 108 may obtain the historical behaviour-based pattern of the entity. The historical behaviour-based pattern may be indicative of historical operations performed by the entity at the particular time.

Subsequently, the anomaly detection engine 108 may compare the historical operations with the one or more operations to detect the anomaly. In an example, the anomaly may be detected when a deviation of at least one operation of the one or more operations from the historical operations is detected. Thus, by comparing the historical operations with the one or more operations, the anomaly detection model may enable implementation of the behavior-based monitoring for detecting anomalies related to typical behavior of the entity.

In an example, for processing the real-time operation data and the operational information, the anomaly detection engine 108 may obtain a historical role-based pattern for the entity. The historical role-based pattern may be indicative of ideal operations performed by an ideal entity having authorization to operate within an ideal OT environment according to the authorization details and responsibilities. The ideal operations may be authentic operations, the ideal entity may be an authentic entity, and the ideal OT environment may be an authentic OT environment. Thus, the historical role-based pattern may be indicative of authentic operations that should be performed at a respective role assigned to the authentic entity.

Subsequently, the anomaly detection engine 108 may compare the ideal operations with the one or more operations to detect the anomaly. In an example, the anomaly may be detected when a deviation of at least one operation of the one or more operations from the ideal operations is detected. Thus, by comparing the ideal operations with the one or more operations, the anomaly detection model may enable implementation of the role-based monitoring for detecting anomalies related to the role assigned to the entity within the organization.

In an example, the OT security engine 110 of the system 100 may initiate one or more preventive actions within the OT environment 202 upon detecting an anomaly in at least one of the one or more operations.

In an example, the one or more preventive actions may include alerting a supervisor about the anomaly so that the supervisor may proactively engage in adversary pursuit and threat hunting. For alerting the supervisor, the OT security engine 110 may generate an alert notification for transmission to the supervisor on the supervisor device 204. The alert notification may be indicative of the anomaly.

In an example, the one or more preventive actions may include controlling the OT assets 208 to prevent execution of the one or more operations for which the anomaly is detected. For controlling the OT assets 208, the OT security engine 110 may generate a suspension signal for transmission to one or more devices associated with the organization. The one or more devices may be any of the OT assets 208. The suspension signal may be to prevent execution of the one or more operations for which the anomaly is detected. For example, if a malicious user is trying to copy and paste some confidential data to an external memory using the laptop 208-6 which is typically operated by the user B 210-2, the anomaly detection engine may detect, based on the behavior-based monitoring, that user B 210-2 typically does not try to copy and paste the confidential data. In addition or alternatively, if user B 210-2 is not authorized to copy and paste the confidential data according to the role and responsibilities assigned to the user B 210-2, the anomaly detection engine may detect, based on the role-based monitoring, that user B 210-2 is not authorized to copy and paste the confidential data. Accordingly, the OT security engine 110 may generate the alert notification and the communication module 218 may transmit the alert notification to the supervisor device 204 informing about the attempt to copy and paste the confidential data. Further, the OT security engine 110 may generate the suspension signal and the communication module 218 of the system 100 may transmit the suspension signal to the laptop 208-6. The laptop 208-6 may disallow pasting of the confidential data into the external memory. Thus, the described approaches provide a simple and robust analytical methodology for early, quick, efficient, and automated detection of anomalies in the OT environment. Further, the anomaly detection model may facilitate in providing a dynamic and adaptive cybersecurity system.

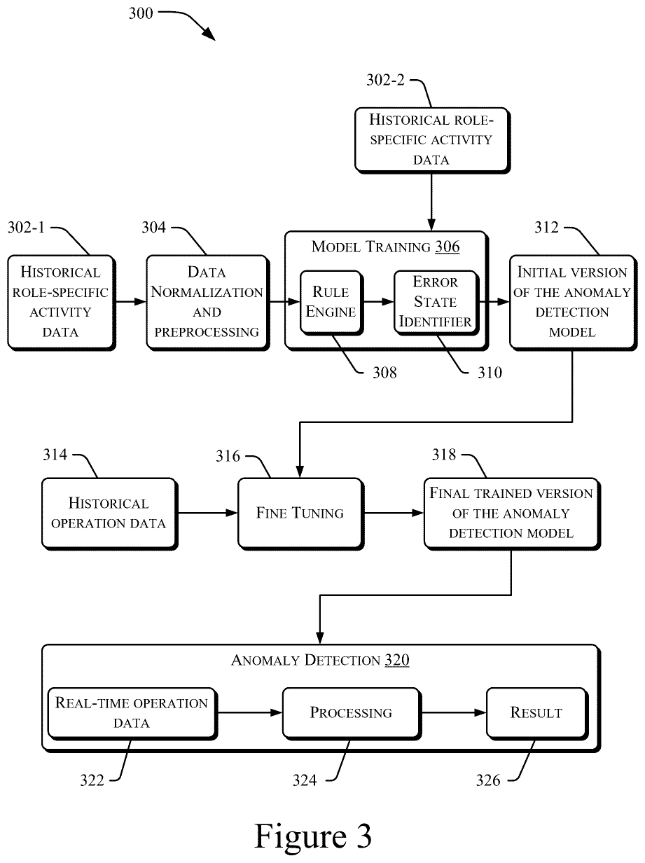

FIG. 3 illustrates a data flow diagram 300 for detecting an anomaly in an OT environment, say the OT environment 202, according to an example. The order in which the data flow diagram 300 is described is not intended to be construed as a limitation, and some of the described components of the data flow diagram 300 may be combined in a different order to implement a data flow according to the data flow diagram 300, or an alternative data flow.

The data flow in the data flow diagram 300 may be implemented in a suitable hardware, computer-readable instructions, or combination thereof. The steps of such data flow diagram 300 may be performed by either a system under the instruction of machine executable instructions stored on a non-transitory computer-readable medium or by dedicated hardware circuits, microcontrollers, or logic circuits. For example, the data flow in the data flow diagram 300 may be performed by components of the system 100. In an implementation, the data flow of the data flow diagram 300 may be performed under an “as a service” delivery model, where the system 100 operated by a provider, receives programmable code. In an implementation, the data flow of the data flow diagram 300 and the system 100 may be implemented within a demilitarized zone (DMZ) which separates the OT environment from a business and logistics zone of an organization. The demilitarized zone is typically considered as level 3.5 in a Purdue Model usually employed by industries as a reference model for data flows. Herein, some examples are also intended to cover non-transitory computer-readable medium, for example, digital data storage media, which are computer-readable and encode computer-executable instructions, where said instructions perform some or all the steps of the data flow of the data flow diagram 300.

In one example implementation, the data flow diagram 300 of FIG. 3 illustrates historical role-specific activity data 302-1 and 302-2. The historical role-specific activity data 302-1 and 302-2 may be the historical role-specific activity data 224 explained with reference to FIG. 2A. In an example, the historical role-specific activity data 224 may be divided into the historical role-specific activity data 302-1 and the historical role-specific activity data 302-2. The historical role-specific activity data 302-1 may be utilized for training of an anomaly detection model. The historical role-specific activity data 302-1 may be utilized for testing of the anomaly detection model.

The data flow diagram 300 illustrates a block 304 for data normalization and pre-processing. At block 304, the historical role-specific activity data 302-1 may be normalized and pre-processed.

The data flow diagram 300 illustrates a block 306 for model training. The historical role-specific activity data 302-1 after normalization and pre-processing, and the historical role-specific activity data 302-2 may be fed to the block 306 for model training. In an example, the historical role-specific activity data 302-2 may also be normalized and pre-processed before being fed to the block 306 for model training.

The block 306 for model training includes a rule engine 308 and an error state identifier 310. The rule engine 308 may recognize the historical role-based patterns for one or more entities using the normalized and pre-processed historical role-specific activity data. A historical role-based pattern for an entity may indicate typical patterns in operational behavior of the entity using the normalized and pre-processed historical ICS data. In an example, the typical patterns may be recognized based on how and what activities the entity typically perform according to role and responsibilities assigned to the entity for operating within the OT environment. In another example, the typical patterns may be recognized based on how and what data the entity typically accesses or modifies according to role and responsibilities assigned to the entity for operating within the OT environment. Based on the typical patterns, the rule engine 308 may create rules for categorizing a particular action taken by a particular entity as one of a legitimate action and a malicious action for detection of the anomaly.

The error state identifier 310 may test the rules created by the rule engine 308 based on the historical role-specific activity data 302-2 to identify errors in the rules. The error state identifier 310 may improvise the rules according to the identified errors to generate an initial version 312 of the anomaly detection model. In an example, the anomaly detection model may be a generative AI model. In an example, the anomaly detection model may be a convolutional neural networks (CNN) model. In another example, the anomaly detection model may be a recurrent neural network (RNN) model.

The data flow diagram 300 illustrates historical operation data 314. The historical operation data 314 maybe same as the historical operation data 226, explained with reference to FIG. 2A. In an example, the historical operation data 314 may define data based on which the OT environment is typically operated. For example, the historical operation data 314 may include control parameters used for the operation of the OT assets 208 of FIG. 2A, the order of the operation of the OT assets 208, etc.

The data flow diagram 300 further illustrates a block 316 for fine tuning. At block 316, the initial version 312 of the anomaly detection model may be fine-tuned using the historical operation data 314 to generate a final trained version 318 of the anomaly detection model. The anomaly detection model may be utilized, in real-time, for detecting anomalies in the OT environment whenever any action is performed by any entity associated with the organization.

The data flow diagram 300 further illustrates a block 320 for anomaly detection in real-time which is fed with the final trained version 318 of the anomaly detection model. The block 320 further illustrates real-time operation data 322. The real-time operation data 322 may be same as the real-time operation data 114, explained with reference to FIG. 1 and FIG. 2A.

The block 320 further illustrates a block 324 for processing. At block 324, the real-time operation data 322 may be processed utilizing the anomaly detection model to generate result 326, illustrated in FIG. 3, regarding anomalies within the OT environment. At the block 324 for processing, the real-time operation data 322 may also be normalized and pre-processed before generating the result 326 utilizing the anomaly detection model. In an example, the real-time operation data 322 may be processed in the same manner as explained with reference to FIG. 2A to generate the result 326. The result 326 may indicate whether any anomaly is detected in one or more operations indicated by the real-time operation data 322. Based on the result 326, appropriate preventive actions may be initiated, as explained with reference to FIG. 2A.

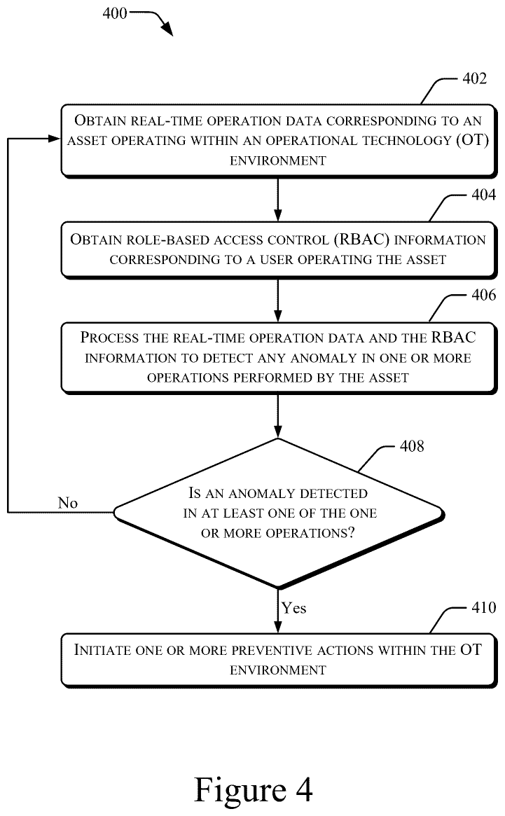

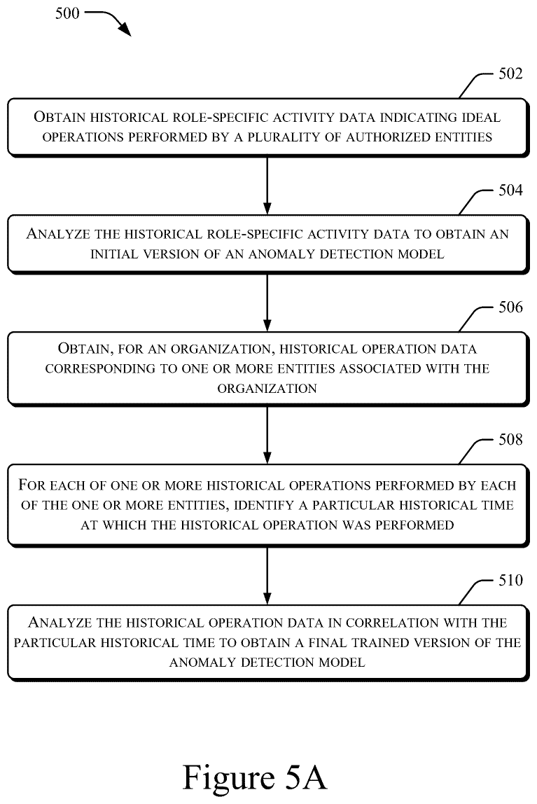

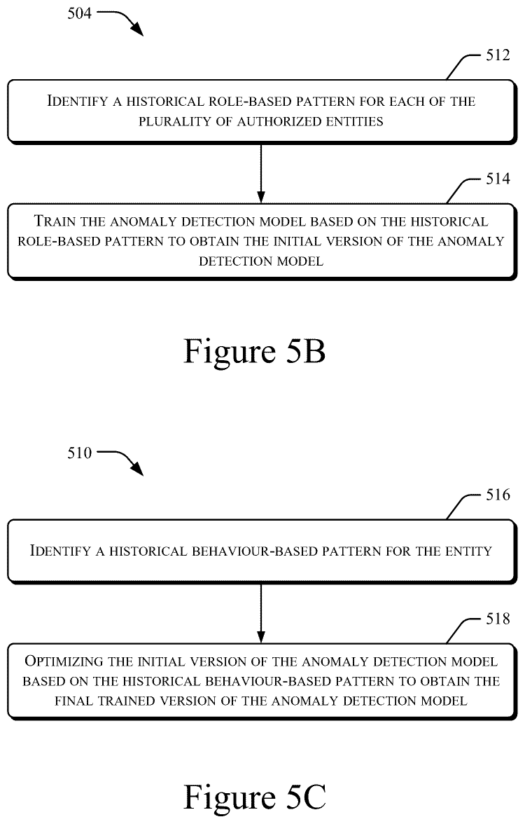

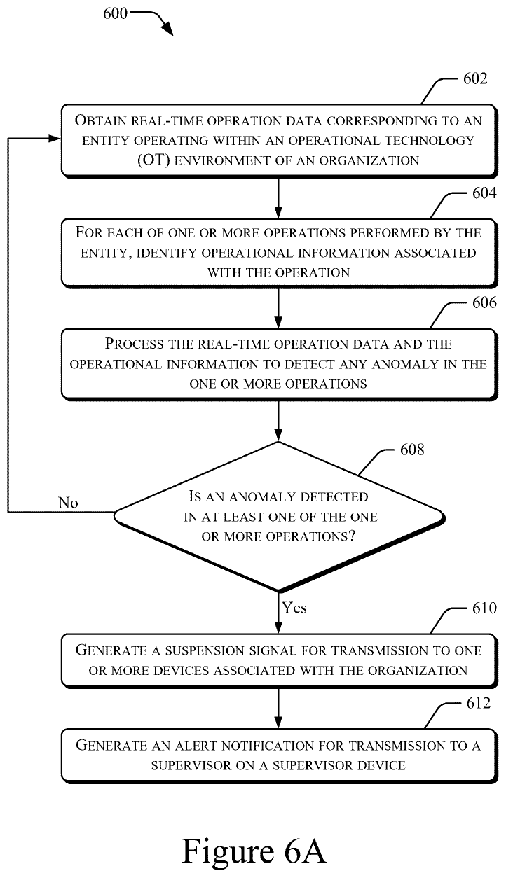

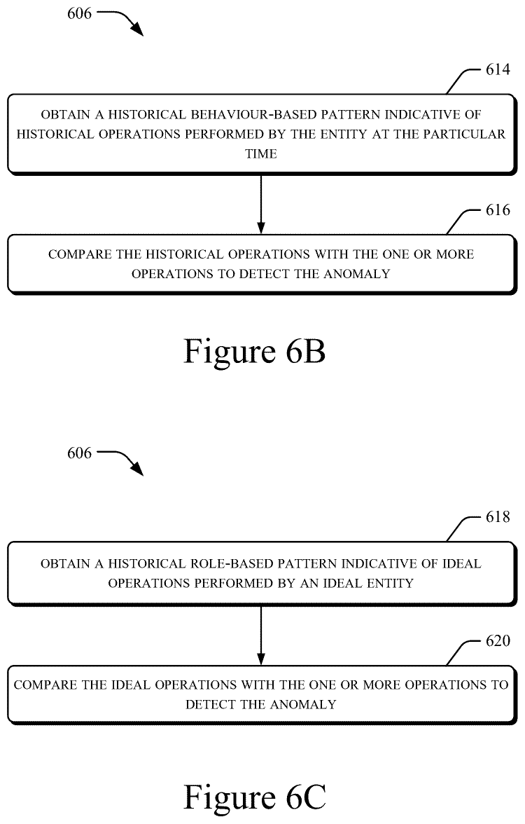

FIG. 4, FIG. 5A, FIG. 5B, FIG. 5C, FIG. 6A, FIG. 6B, and FIG. 6C illustrate example methods 400, 500, 504, 510, 600, 606, and 606, respectively, for detecting an anomaly in an OT environment and training of a machine learning model for detecting an anomaly in an OT environment. The order in which the methods are described is not intended to be construed as a limitation, and any number of the described method blocks may be combined in any order to implement the methods, or an alternative method. Further, the methods 400, 500, 504, 510, 600, and 606 may be implemented by processing resource or computing device(s) through any suitable hardware, non-transitory machine-readable instructions, or combination thereof.

It may also be understood that methods 400, 500, 504, 510, 600, and 606 may be performed by programmed computing devices, such as the system 100, as depicted in FIG. 1, FIG. 2A, and FIG. 2B. Furthermore, the methods 400, 500, 504, 510, 600, and 606 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 400, 500, 504, 510, 600, and 606 are described below with reference to the system 100 as described above; other suitable systems for the execution of these methods may also be utilized. Additionally, implementation of the methods 400, 500, 504, 510, 600, and 606 is not limited to such examples.

FIG. 4 illustrates the method 400 for detecting an anomaly in an OT environment of an organization, according to an example.

At block 402, real-time operation data corresponding to an asset, say the asset 208, operating within the OT environment, say the OT environment 202, may be obtained. The real-time operation data may be indicative of one or more operations performed by the asset. In an example, the asset may be a device, a system, or a machine associated with the organization. In an example, the real-time operation data may be obtained from the asset. In another example, the real-time operation data may be obtained from a centralized server, say the server 208-3, managing operations performed within the OT environment of the organization.

At block 404, role-based access control (RBAC) information may be obtained. The RBAC information may be indicative of authorization details and responsibilities assigned to a user, say the user 210, operating the asset. For example, the organization may have users which are assigned with respective roles such as “operator”, “engineer”, and “supervisor”. According to the role assigned by the organization, the user may have a pre-defined set of responsibilities and access permissions which may be referred to as the authorization details and responsibilities.

At block 406, the real-time operation data and the RBAC information may be processed to detect any anomaly in the one or more operations. In an example, the real-time operation data and the RBAC information may be processed utilizing an anomaly detection model. The anomaly detection model may be a generative artificial intelligence (AI) model trained on historical data to detect anomalies within the OT environment. In an example, an anomaly may be detected whenever any operation in the one or more operations is detected that does not correspond to the authorization details and responsibilities assigned to the user.

At block 408, it is determined whether an anomaly is detected in at least one of the one or more operations. If any anomaly is not detected in the one or more operations, the method may move back to block 402 and the real-time operation data may be continuously obtained and processed.

Upon detecting an anomaly in at least one of the one or more operations, at block 410, one or more preventive actions may be initiated within the OT environment. In an example, the one or more preventive actions may include alerting a supervisor about the anomaly so that the supervisor may proactively engage in adversary pursuit and threat hunting. In an example, the one or more preventive actions may include controlling one or more devices associated with the organization to prevent execution of the one or more operations for which the anomaly is detected. Thus, the described approaches provide a simple and robust analytical methodology for early, quick, efficient, and automated detection of anomalies in the OT environment. Further, the anomaly detection model may facilitate in providing a dynamic and adaptive cybersecurity system.

FIG. 5A illustrates the method 500 for training of a machine learning model for detecting an anomaly in an OT environment of an organization, according to an example.

At block 502, historical role-specific activity data may be obtained. The historical role-specific activity data may indicate ideal operations performed within one or more OT environments of one or more organizations, by a plurality of authorized entities authorized to perform operations corresponding to roles assigned in at least one of the one or more organizations. In an example, the historical role-specific activity data may indicate ideal operations generally performed according to each of a plurality of pre-defined roles across different organizations. In an example, the historical role-specific activity data may indicate industry-specific ideal operations performed according to each of the plurality of pre-defined roles across different organizations belonging to a particular industry. Examples of the plurality of pre-defined roles may include, but are not limited to, an operator, an engineer, and a supervisor. For example, the historical role-specific activity data may indicate ideal operations performed by engineers in a manufacturing industry.

At block 504, the historical role-specific activity data may be analyzed to obtain an initial version of an anomaly detection model. The anomaly detection model may be the machine learning model. In an example, the initial version of the anomaly detection model may be utilized to implement role-based monitoring of operations performed within the OT environment. The role-based monitoring may involve detecting any particular operation that is performed by a particular entity which is not authorized to perform that particular operation according to the role and responsibilities assigned to the particular entity.

In addition or alternatively, at block 506, historical operation data corresponding to one or more entities associated with an organization may be obtained. The organization may be a particular organization for which the anomaly detection model is to be utilized for detection of anomalies. The historical operation data may be indicative of one or more historical operations performed by each of the one or more entities within the OT environment of the organization. In an example, the historical operation data may include historical timing information for each of the one or more historical operations. The historical timing information may be indicative of a particular historical time at which the historical operation was performed. In an example, the historical operation data may be obtained from assets, say the OT assets 208, or users, say the OT users 210, operating within the OT environment.

At block 508, for each of the one or more historical operations, identify the particular historical time may be identified at which the historical operation was performed.

At block 510, the historical operation data may be analyzed in correlation with the particular historical time to obtain a final trained version of the anomaly detection model. The final trained version of the anomaly detection model may be utilized to implement behavior-based monitoring of operations performed within the OT environment of the organization for which the final trained version of the anomaly detection model is obtained. The behavior-based monitoring may involve detecting any particular operation that is performed by an entity that does not typically perform that particular operation at the time at which the particular operation is performed.

FIG. 5B illustrates the method 504 for analyzing the historical role-specific activity data at block 504 of FIG. 5A, according to an example. In an example, for each of the plurality of authorized entities, corresponding RBAC details may indicate authorization details and responsibilities assigned to the authorized entity for operating within the one or more OT environments as per the roles assigned to the authorized entity in at least one of the one or more organizations.

At block 512, a historical role-based pattern may be identified for each of the plurality of authorized entities. The historical role-based pattern may be indicative of a correlation between the ideal operations and the corresponding RBAC details. Thus, the historical role-based pattern provides a typical pattern of operations performed by users that are assigned a particular role within the one or more organizations. For example, the historical role-based pattern may indicate what operations are typically performed by engineers within one or more organizations.

At block 514, the anomaly detection model may be trained based on the historical role-based pattern to obtain the initial version of the anomaly detection model.

FIG. 5C illustrates the method 510 for analyzing the historical operation data at block 510 of FIG. 5A, according to an example.

At block 516, a historical behaviour-based pattern may be identified for the asset. The historical behaviour-based pattern may be indicative of a correlation between the one or more historical operations and the particular historical time. Thus, the historical behaviour-based pattern provides a typical pattern of how assets within the OT environment operate at different times. For example, the historical behaviour-based pattern may indicate what operations are performed by the asset at a particular time. For instance, actuators within the OT environment may operate for one hour and then rest without operating for five minutes. Similar patterns may be detected for the assets operating within the OT environment in correlation with the time of operation.

At block 518, the initial version of the anomaly detection model may be optimized based on the historical behaviour-based pattern to obtain the final trained version of the anomaly detection model.

FIG. 6 illustrates the method 600 for detecting an anomaly in an OT environment of an organization, according to another example.

At block 602, real-time operation data corresponding to an entity operating within the OT environment may be obtained. The real-time operation data may be indicative of one or more operations performed by the entity within the OT environment. In an example, the entity may be an asset, say the asset 208, associated with the organization. In another example, the entity may be a user, say the user 210, operating the asset associated with the organization. In an example, the real-time operation data may be obtained from OT asset, say the OT assets 208, operating within the OT environment. In another example, the real-time operation data may be obtained from a centralized server, say the server 208-3, managing operations performed within the OT environment of the organization. The real-time operation data may be obtained for real-time monitoring of the one or more operations to enable detection of the anomalies.

At block 604, for each of the one or more operations, operational information associated with the operation may be identified. In an example, the operational information may comprise at least one of timing information and role-based access control (RBAC) information. The timing information may indicate a particular time at which the operation was performed. In an example, the real-time operation data include a time-stamp tag corresponding to each of the one or more operations and the timing information may accordingly be identified based on the time-stamp tag. Further, the RBAC information may indicate authorization details and responsibilities assigned to the entity for operating within the OT environment. For example, the organization may have users which are assigned with respective roles such as “operator”, “engineer”, and “supervisor”. According to the role assigned by the organization, the entity may have a pre-defined set of responsibilities and access permissions which may be referred to as the authorization details and responsibilities. In an example, the anomaly detection model, obtained through training in FIGS. 5A, 5B, and 5C, may be implemented to identify the operational information.

At block 606, the real-time operation data and the operational information may be processed to detect any anomaly in the one or more operations. In an example, the anomaly detection model may be utilized to process the real-time operation data and the operational information. In an example, an anomaly may be detected whenever any operation in the one or more operations is detected that is not typically performed by the entity at the particular time while operating within the OT environment. In addition or alternatively, an anomaly may be detected whenever any operation in the one or more operations is detected that does not correspond to the authorization details and responsibilities assigned to the entity.

At block 608, it is determined whether an anomaly is detected in at least one of the one or more operations. If any anomaly is not detected in the one or more operations, the method may move back to block 602 and the real-time operation data may be continuously obtained and processed.

Upon detecting an anomaly in at least one of the one or more operations, one or more preventive actions may be initiated within the OT environment. In an example, the one or more preventive actions may include controlling one or more devices associated with the organization to prevent execution of the one or more operations for which the anomaly is detected. For instance, at block 610, a suspension signal may be generated for transmission to one or more devices associated with the organization. The one or more device may be any of the OT assets. The suspension signal may be to prevent execution of the one or more operations for which the anomaly is detected. For example, if a malicious user is trying to copy and paste some confidential data to an external memory using a particular laptop which is typically operated by a particular authentic user, based on the behavior-based monitoring, it may be detected that the particular authentic user typically does not try to copy and paste the confidential data. In addition or alternatively, if the particular authentic user is not authorized to copy and paste the confidential data according to the role and responsibilities assigned to the particular authentic user, based on the role-based monitoring, it may be detected that the particular authentic user is not authorized to copy and paste the confidential data. Further, the suspension signal may be generated and transmitted to the particular. The particular laptop may disallow pasting of the confidential data into the external memory.

In an example, the one or more preventive actions may include alerting a supervisor about the anomaly so that the supervisor may proactively engage in adversary pursuit and threat hunting. For instance, at block 612, an alert notification may be generated for transmission to the supervisor on a supervisor device. The alert notification may be indicative of the anomaly. For instance, the alert notification may be generated and transmitted to the supervisor device informing about the attempt to copy and paste the confidential data. Thus, the described approaches provide a simple and robust analytical methodology for early, quick, efficient, and automated detection of anomalies in the OT environment.

FIG. 6B illustrates the method 606 for processing the real-time operation data and the operational information, say the timing information, at block 606 of FIG. 6A, according to an example.

At block 614, obtain the historical behaviour-based pattern of the entity. The historical behaviour-based pattern may be indicative of historical operations performed by the entity at the particular time.

At block 616, the historical operations may be compared with the one or more operations to detect the anomaly. In an example, the anomaly may be detected when a deviation of at least one operation of the one or more operations from the historical operations is detected. Thus, by comparing the historical operations with the one or more operations, the anomaly detection model may enable implementation of the behavior-based monitoring for detecting anomalies related to typical behavior of the entity.

FIG. 6C illustrates the method 606 for processing the real-time operation data and the operational information, say the RBAC information, at block 606 of FIG. 6A, according to an example.

At block 618, a historical role-based pattern may be obtained for the entity. The historical role-based pattern may be indicative of ideal operations performed by an ideal entity having authorization to operate within an ideal OT environment according to the authorization details and responsibilities. The ideal operations may be authentic operations, the ideal entity may be an authentic entity, and the ideal OT environment may be an authentic OT environment. Thus, the historical role-based pattern may be indicative of authentic operations that should be performed at a respective role assigned to the authentic entity.

At block 620, the ideal operations may be compared with the one or more operations to detect the anomaly. In an example, the anomaly may be detected when a deviation of at least one operation of the one or more operations from the ideal operations is detected. Thus, by comparing the ideal operations with the one or more operations, the anomaly detection model may enable implementation of the role-based monitoring for detecting anomalies related to the role assigned to the entity within the organization.

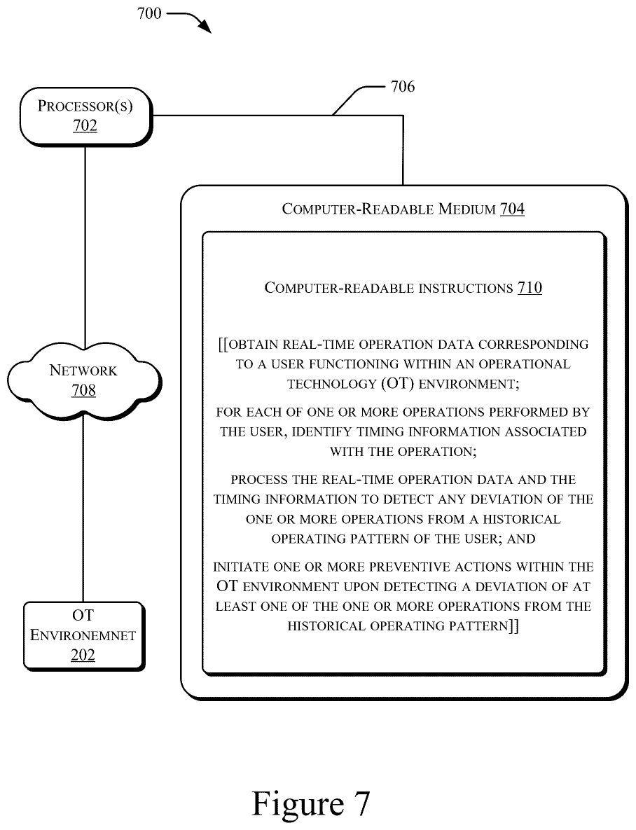

FIG. 7 illustrates a computing environment 700 implementing a non-transitory computer-readable medium for detecting an anomaly in an OT environment, according to an example. In an example, the computing environment 700 includes processor(s) 702 communicatively coupled to a non-transitory computer-readable medium 704 through a communication link 706. In one example, the communication link 706 may be similar to the communication network 206, as described in conjunction with the preceding figures. In an example implementation, the computing environment 700 may be for example, the computing environment 200. In an example, the processor(s) 702 may have one or more processing resources for fetching and executing computer-readable instructions from the non-transitory computer-readable medium 704. The processor(s) 702 and the non-transitory computer-readable medium 704 may be implemented, for example, in the system 100 (as has been described in conjunction with the preceding figures).

The non-transitory computer-readable medium 704 may be, for example, an internal memory device or an external memory device. In an example implementation, the communication link 706 may be a network communication link. The processor(s) 702 and the non-transitory computer-readable medium 704 may also be communicatively coupled to the OT environment 202 over a network 708. The network 708 may be similar to the communication network 206 described in conjunction with FIG. 2.

In an example implementation, the non-transitory computer-readable medium 704 may include a set of computer-readable instructions 710 which may be accessed by the processor(s) 702 through the communication link 706. Referring to FIG. 7, in an example, the non-transitory computer-readable medium 704 may include instructions 710 that may cause the processor(s) 702 to obtain real-time operation data corresponding to a user functioning within the OT environment of an organization. The real-time operation data may be indicative of one or more operations performed by the user, say the user 210, within the OT environment, say the OT environment 202, of the organization. In an example, the real-time operation data may be obtained from one or more assets, say the assets 208, operating within the OT environment. In another example, the real-time operation data may be obtained from a centralized server, say the server 208-3, managing operations performed within the OT environment of the organization.

In an example, for each of the one or more operations, the instructions 710 may further cause the processor(s) 702 to identify timing information associated with the operation. The timing information may indicate a particular time at which the operation was performed.

In one example, the instructions 710 may cause the processor(s) 702 to process the real-time operation data and the timing information to detect any deviation of the one or more operations from a historical operating pattern of the user in terms of the particular time. In an example, the real-time operation data and the timing information may be processed utilizing an anomaly detection model. The anomaly detection model may be a generative artificial intelligence (AI) model trained on historical data to detect anomalies within the OT environment. In an example, the historical operating pattern may generated using the anomaly detection model. The historical operating pattern may be indicative of historical operations performed by the user at the particular time.

In one example, the instructions 710 may cause the processor(s) 702 to initiate one or more preventive actions within the OT environment upon detecting a deviation of at least one of the one or more operations from the historical operating pattern.

In an example, the one or more preventive actions may include alerting a supervisor about the deviation so that the supervisor may proactively engage in adversary pursuit and threat hunting. For alerting the supervisor, the instructions 710 may cause the processor(s) 702 to generate an alert notification for transmission to the supervisor on a supervisor device. The alert notification may be indicative of the at least one operation.

In an example, the one or more preventive actions may include controlling OT assets, say the OT assets 208, to prevent execution of the at least one operation for which the deviation is detected. For controlling the OT assets, the instructions 710 may cause the processor(s) 702 to generate a suspension signal for transmission to one or more devices associated with the organization. The one or more device may be any of the OT assets. The suspension signal may be to prevent execution of the at least one operation.

In an example, the anomaly detection model may be trained for utilizing for detecting the deviation. In an example, for training the anomaly detection model, the instructions 710 may cause the processor(s) 702 to obtain, for the organization, historical operation data corresponding to one or more entities associated with the organization. The historical operation data may be indicative of one or more historical operations performed by each of the one or more entities within the OT environment of the organization. In an example, the historical operation data may include historical timing information for each of the one or more historical operations. The historical timing information may indicate a particular historical time at which the historical operation was performed.

Subsequently, for each of the one or more historical operations, the instructions 710 may cause the processor(s) 702 to identify the particular historical time at which the historical operation was performed.

The instructions 710 may then cause the processor(s) 702 to analyze the historical operation data in correlation with the particular historical time to obtain the anomaly detection model. The anomaly detection model may be utilized to implement behavior-based monitoring of operations performed within the OT environment of the organization for which the anomaly detection model is obtained. The behavior-based monitoring may involve detecting any particular operation that is performed by a user that does not typically perform that particular operation at the time at which the particular operation is performed.

In an example, to analyze the historical operation data, the instructions 710 may then cause the processor(s) 702 to identify a historical behaviour-based pattern for the user. The historical behaviour-based pattern may be indicative of a correlation between the one or more historical operations and the particular historical time. Thus, the historical behaviour-based pattern provides a typical pattern of how users operate within the OT environment at different times. For example, the historical behaviour-based pattern may indicate what operations are performed by the user at a particular time.

Subsequently, the instructions 710 may then cause the processor(s) 702 to analyze the historical behaviour-based pattern to obtain the anomaly detection model.

In an example, for processing the real-time operation data and the timing information, the instructions 710 may cause the processor(s) 702 to obtain the historical behaviour-based pattern of the user. The historical behaviour-based pattern may be indicative of historical operations performed by the user at the particular time. Further, the instructions 710 may cause the processor(s) 702 to compare the historical operations with the one or more operations to detect the deviation.

Thus, the described approaches provide a simple and robust analytical methodology for early, quick, efficient, and automated detection of anomalies in the OT environment. Further, the anomaly detection model may facilitate in providing a dynamic and adaptive cybersecurity system.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a data acquisition engine to:
obtain real-time operation data corresponding to an entity operating within an operational technology (OT) environment of an organization, the real-time operation data being indicative of one or more operations performed by the entity within the OT environment of the organization;
an anomaly detection engine implementing an anomaly detection model to:
for each of the one or more operations, identify operational information associated with the operation, the operational information comprising at least one of timing information and role-based access control (RBAC) information, wherein the timing information indicates a particular time at which the operation was performed, and wherein the RBAC information indicates authorization details and responsibilities assigned to the entity for operating within the OT environment; and
process, utilizing the anomaly detection model, the real-time operation data and the operational information to detect any anomaly in the one or more operations; and
an OT security engine to initiate one or more preventive actions within the OT environment upon detecting an anomaly in at least one of the one or more operations.

2. The system of claim 1, wherein the entity is one of an asset associated with the organization and a user operating the asset.

3. The system of claim 1, wherein the system comprises a model training engine to:
obtain historical role-specific activity data indicating ideal operations performed within one or more OT environments of one or more organizations, by a plurality of authorized entities authorized to perform operations corresponding to roles assigned in at least one of the one or more organizations;
analyze the historical role-specific activity data to obtain an initial version of the anomaly detection model;
obtain, for the organization, historical operation data corresponding to one or more entities associated with the organization, wherein the historical operation data is indicative of one or more historical operations performed by each of the one or more entities within the OT environment of the organization;
for each of the one or more historical operations, identify a particular historical time at which the historical operation was performed; and
analyze the historical operation data in correlation with the particular historical time to obtain a final trained version of the anomaly detection model.

4. The system of claim 3, wherein for each of the plurality of authorized entities, corresponding RBAC details indicate authorization details and responsibilities assigned to the authorized entity for operating within the one or more OT environments as per the roles assigned to the authorized entity in at least one of the one or more organizations, and wherein to analyze the historical role-specific activity data, the model training engine is to:
identify a historical role-based pattern for each of the plurality of authorized entities, wherein the historical role-based pattern is indicative of a correlation between the ideal operations and the corresponding RBAC details; and
train the anomaly detection model based on the historical role-based pattern to obtain the initial version of the anomaly detection model.

5. The system of claim 3, wherein to analyze the historical operation data, the model training engine is to:
identify a historical behaviour-based pattern for the entity, wherein the historical behaviour-based pattern is indicative of a correlation between the one or more historical operations and the particular historical time; and
optimize the initial version of the anomaly detection model based on the historical behaviour-based pattern to obtain the final trained version of the anomaly detection model.

6. The system of claim 1, wherein the one or more preventive actions include at least one of:
generating a suspension signal for transmission to one or more devices associated with the organization, wherein the suspension signal is to prevent execution of the one or more operations for which the anomaly is detected; and
generating an alert notification for transmission to a supervisor on a supervisor device, wherein the alert notification is indicative of the anomaly.

7. The system of claim 1, wherein to process the real-time operation data and the operational information, the anomaly detection engine is to:
obtain a historical behaviour-based pattern of the entity, wherein the historical behaviour-based pattern is indicative of historical operations performed by the entity at the particular time; and
compare the historical operations with the one or more operations to detect the anomaly, wherein detecting the anomaly comprises detecting a deviation of at least one operation of the one or more operations from the historical operations.

8. The system of claim 1, wherein to process the real-time operation data and the operational information, the anomaly detection engine is to:
obtain a historical role-based pattern for the entity, wherein the historical role-based pattern is indicative of ideal operations performed by an ideal entity having authorization to operate within an ideal OT environment according to the authorization details and responsibilities; and
compare the ideal operations with the one or more operations to detect the anomaly, wherein detecting the anomaly comprises detecting a deviation of at least one operation of the one or more operations from the ideal operations.

9. A method comprising:
obtaining real-time operation data corresponding to an asset operating within an operational technology (OT) environment of an organization, the real-time operation data being indicative of one or more operations performed by the asset;
obtaining role-based access control (RBAC) information indicative of authorization details and responsibilities assigned to a user operating the asset;
processing, utilizing an anomaly detection model, the real-time operation data and the RBAC information to detect any anomaly in the one or more operations; and
initiating one or more preventive actions within the OT environment upon detecting an anomaly in at least one of the one or more operations.

10. The method of claim 9, wherein the method comprises:
for each of the one or more operations, obtaining timing information indicative of a particular time at which the operation was performed;
processing, utilizing the anomaly detection model, the real-time operation data and the timing information to detect any other anomaly in the one or more operations; and
initiating one or more additional preventive actions within the OT environment upon detecting another anomaly in at least one of the one or more operations.

11. The method of claim 9, wherein the method comprises:
obtaining historical role-specific activity data indicating ideal operations performed within one or more OT environments of one or more organizations, by a plurality of authorized entities authorized to perform operations corresponding to roles assigned in at least one of the one or more organizations;
analyzing the historical role-specific activity data to obtain an initial version of the anomaly detection model;
obtaining, for the organization, historical operation data corresponding to one or more assets associated with the organization, wherein the historical operation data is indicative of one or more historical operations performed by each of the one or more assets within the OT environment of the organization;
for each of the one or more historical operations, identifying a particular historical time at which the historical operation was performed; and
analyzing the historical operation data in correlation with the particular historical time to obtain a final trained version of the anomaly detection model.

12. The method of claim 11, wherein for each of the plurality of authorized entities, corresponding RBAC details indicate authorization details and responsibilities assigned to the authorized entity for operating within the one or more OT environments as per the roles assigned to the authorized entity in at least one of the one or more organizations, and wherein analyzing the historical role-specific activity data comprises:
identifying a historical role-based pattern for each of the plurality of authorized entities, wherein the historical role-based pattern is indicative of a correlation between the ideal operations and the corresponding RBAC details; and
training the anomaly detection model based on the historical role-based pattern to obtain the initial version of the anomaly detection model.

13. The method of claim 11, wherein analyzing the historical operation data comprises:
identifying a historical behaviour-based pattern for the asset, wherein the historical behaviour-based pattern is indicative of a correlation between the one or more historical operations and the particular historical time; and
optimizing the initial version of the anomaly detection model based on the historical behaviour-based pattern to obtain the final trained version of the anomaly detection model.

14. The method of claim 9, wherein the one or more preventive actions include at least one of:
generating a suspension signal for transmission to one or more devices associated with the organization, wherein the suspension signal is to prevent execution of the one or more operations for which the anomaly is detected; and
generating an alert notification for transmission to a supervisor on a supervisor device, wherein the alert notification is indicative of the anomaly.

15. The method of claim 9, wherein processing the real-time operation data and the RBAC information comprises:
obtaining a historical role-based pattern for the asset, wherein the historical role-based pattern is indicative of ideal operations performed by an ideal entity having authorization to operate within an ideal OT environment according to the authorization details and responsibilities; and
comparing the ideal operations with the one or more operations to detect the anomaly, wherein detecting the anomaly comprises detecting a deviation of at least one operation of the one or more operations from the ideal operations.

16. A non-transitory computer-readable medium comprising instructions for detecting an anomaly in an operational technology (OT) environment, the instructions being executable by a processing resource to:
obtain real-time operation data corresponding to a user functioning within an operational technology (OT) environment of an organization, the real-time operation data being indicative of one or more operations performed by the user within the OT environment of the organization;
for each of the one or more operations, identify timing information associated with the operation, the timing information indicating a particular time at which the operation was performed;
process, utilizing an anomaly detection model, the real-time operation data and the timing information to detect any deviation of the one or more operations from a historical operating pattern of the user in terms of the particular time; and
initiate one or more preventive actions within the OT environment upon detecting a deviation of at least one of the one or more operations from the historical operating pattern.

17. The non-transitory computer-readable medium of claim 16, wherein the instructions are executable by the processing resource to:
obtain, for the organization, historical operation data corresponding to one or more entities associated with the organization, wherein the historical operation data is indicative of one or more historical operations performed by each of the one or more entities within the OT environment of the organization;
for each of the one or more historical operations, identify a particular historical time at which the historical operation was performed; and
analyze the historical operation data in correlation with the particular historical time to obtain the anomaly detection model.

18. The non-transitory computer-readable medium of claim 17, wherein to analyze the historical operation data, the instructions are executable by the processing resource to:
identify a historical behaviour-based pattern for the user, wherein the historical behaviour-based pattern is indicative of a correlation between the one or more historical operations and the particular historical time; and
analyze the historical behaviour-based pattern to obtain the anomaly detection model.

19. The non-transitory computer-readable medium of claim 16, wherein the one or more preventive actions include at least one of:
generating a suspension signal for transmission to one or more devices associated with the organization, wherein the suspension signal is to prevent execution of the at least one operation; and
generating an alert notification for transmission to a supervisor on a supervisor device, wherein the alert notification is indicative of the at least one operation.

20. The non-transitory computer-readable medium of claim 16, wherein to process the real-time operation data and the timing information, the instructions are executable by the processing resource to:
obtain a historical behaviour-based pattern of the user, wherein the historical behaviour-based pattern is indicative of historical operations performed by the user at the particular time; and
compare the historical operations with the one or more operations to detect the deviation.
